(19) United States
(12) Patent Application Publication
(10) Pub. No.: US 2026/0178224 A1
(43) Pub. Date: Jun. 25, 2026

(54) SELECTIVELY BYPASSING AN EXTERNAL CACHE OF A STORAGE SYSTEM FOR LARGE READS BASED ON SATURATION LATENCY AND THROUGHPUT OF THE EXTERNAL CACHE

(71) Applicant: NetApp, Inc., San Jose, CA (US)

(72) Inventors: Javier Tsuyoshi Takimoto, Missouri City, TX (US); Mohammad Hossein Hajkazemi, Boston, MA (US); Joseph Brown, JR., Raleigh, NC (US)

(73) Assignee: NetApp, Inc., San Jose, CA (US)

(21) Appl. No.: 19/183,981

(22) Filed: Apr. 21, 2025

Related U.S. Application Data
(60) Provisional application No. 63/737,458, filed on Dec. 20, 2024.

(51) Int. Cl. G06F 3/06

(52) U.S. Cl. CPC G06F 3/0656; G06F 3/0604; G06F 3/0679

(57) ABSTRACT

Systems and methods for selectively bypassing an external cache (EC) of a storage system are provided. In one example, when the EC backing storage device is saturated, reads bypass the EC and are completed via a redundant array of independent disks (RAID) subsystem of the storage system. One or more performance metrics for the EC backing storage device may be monitored to predict one or more saturation thresholds (e.g., in terms of latency and/or throughput). Based on this monitoring, tuning may be performed to drive utilization of the EC into a “knee region” of a performance (or response) curve of the EC backing storage device. For example, the depth of one or more request queues at the front-end of an EC lookup may be manipulated based on a current measure of saturation relating to the EC backing storage device to limit the number of in-flight reads pending for the EC.

### CROSS-REFERENCE TO RELATED APPLICATIONS

This application claims the benefit of priority of U.S. Provisional Application No. 63/737,458, filed on Dec. 20, 2024, which is hereby incorporated by reference in its entirety for all purposes.

### TECHNICAL FIELD

Various embodiments of the present disclosure generally relate to virtual storage systems. In particular, some embodiments relate to an approach for selectively bypassing an external cache (EC) implemented by a file system of a storage system by monitoring and calculating various metrics associated with latency (e.g., an average read latency over a monitoring interval) and/or throughput (e.g., an average input/output operations per second (IOPS) or simply operations per second (OPS) over the monitoring interval) relating to reads (e.g., EC lookups) from the EC backing storage device.

### BACKGROUND

When a file system of a storage system, such as a storage server computing device, receives a write request, the file system commits the data to permanent storage before the request is confirmed to the writer. Otherwise, if the storage system were to experience a failure with data only in volatile memory, that data would be lost, and underlying file structures could become corrupted. Physical storage appliances commonly use battery-backed high-speed non-volatile random-access memory (NVRAM) as a journaling storage media to journal writes and accelerate write performance while providing permanence, because writing to memory is much faster than writing to storage (e.g., disk).

To enhance read performance, storage systems may also implement a buffer cache in the form of an in-memory cache to cache data that is read from data storage media (e.g., a storage array associated with the storage system) as well as data modified by write requests. As a write request is received, the operation and/or the data or a pointer thereto can first be written to the NVRAM (to ensure data is protected and provide a quick write acknowledgment), then the data can be written to the buffer cache. In this manner, in the event a subsequent access relates to data residing within the buffer cache, the data can be served from local, high performance, low latency memory, thereby improving overall performance of the storage system. The modified data in the buffer cache may be periodically (e.g., every few seconds) flushed to the data storage media. As the buffer cache is generally limited in size, an additional cache level may be provided by a victim cache (which may be referred to herein as an external cache), typically implemented within a slower memory or storage device than utilized by the buffer cache, that stores data evicted from the buffer cache.

When a storage system is hosted by a hyperscaler in a cloud environment, the storage system may be referred to as a virtual storage system. In the context of a virtual storage system (e.g., implemented in the form of a virtual machine (VM) or one or more containers or pods executing within a hypervisor), the backing storage for the external cache may be in the form of ephemeral storage (e.g., local-storage of a compute instance in which the virtual storage system operates or a direct-attached storage device, such as a nonvolatile memory express (NVMe) solid-state disk (SSD) device).

### SUMMARY

Systems and methods are described for selectively bypassing an external cache of a storage system. According to one embodiment, a virtual storage system monitors a measure of saturation throughput and a measure of saturation latency of a backing storage device for an external cache (EC) of the virtual storage system. The virtual storage system receives a read request to retrieve an amount of data greater than or equal to a predetermined or configurable large read threshold. Based at least in part on the measure of saturation throughput and the measure of saturation latency, the virtual storage system selectively (i) performs a lookup into the EC to service the read request or (ii) bypasses the lookup into the EC by directing the read request to a redundant array of independent disks (RAID) subsystem of the virtual storage system to service the read request.

Other features of embodiments of the present disclosure will be apparent from accompanying drawings and detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a block diagram illustrating an environment in which various embodiments may be implemented.

FIG. 2 is a block diagram conceptually illustrating a host of a cloud environment in accordance with an embodiment of the present disclosure.

FIG. 3A is a graph depicting an example of a performance profile for external cache reads, which follows the profile for the backing storage device, with latency plotted against operations per second (OPS) including a first region in which latency remains relatively constant with increasing OPS and a second region in which latency increases sharply with small increases in OPS.

FIG. 3B is a graph depicting the example performance profile of FIG. 3A with a knee region identified in accordance with an embodiment of the present disclosure.

FIG. 4 is a block diagram illustrating various functional components of an external cache bypass mechanism in accordance with an embodiment of the present disclosure.

FIG. 5 is a graph depicting an example of a performance profile for external cache reads and illustrating slopes of various lines through sample data points inside and outside of a knee region in accordance with an embodiment of the present disclosure.

FIG. 6 is a flow diagram illustrating operations for performing saturation monitoring in accordance with an embodiment of the present disclosure.

FIG. 7 is a graph depicting an example of the dynamic nature of the performance profile for external cache reads in accordance with an embodiment of the present disclosure.

FIG. 8 is a flow diagram illustrating operations for performing saturation feedback processing by an external cache queue depth controller in accordance with an embodiment of the present disclosure.

FIG. 9 is a flow diagram illustrating operations for performing tuning based on saturation latency in accordance with an embodiment of the present disclosure.

FIG. 10 is a flow diagram illustrating operations for performing tuning based on saturation throughput in accordance with an embodiment of the present disclosure.

FIG. 11 is a flow diagram illustrating operations for performing read processing by a que depth controller in accordance with an embodiment of the present disclosure.

FIG. 12 illustrates an example computer system in which or with which embodiments of the present disclosure may be utilized.

### DETAILED DESCRIPTION

Systems and methods are described for selectively bypassing an external cache of a storage system. As noted above, a storage system may implement multiple levels of read caching, including a system buffer cache (or simply a “buffer cache”) and an external cache (EC), which may also be referred to as a “victim cache” or a “flash cache.” The buffer cache may be an in-memory (e.g., DRAM-based) cache that represents a first-level cache in which modified data is temporarily buffered until a consistency point (CP) is performed to flush the modified data to persistent storage. Hot data may be retained in the buffer cache to enhance read performance and lower priority data is evicted to the EC (which in the context of a virtual storage system may be backed by ephemeral storage, for example, in the form of NVMe SSD storage), representing a second-level cache that stores overflow or evictions from the buffer cache.

An original goal of such an EC was to accelerate read throughput for small, random reads in the context of a physical (or on-prem) storage system. In the context of a virtual storage system, use of the EC may result in higher latency than reading from persistent storage directly for some workloads (e.g., sequential reads, large reads, and random reads when mixed with sequential reads). This is due to the fact that disk-based storage is typically used as backing storage for the EC in the cloud which is inefficient (high latency) for large reads. Large reads and/or a high volume of reads can overwhelm the EC backing storage device causing read latency to spike as the EC backing storage device cannot keep up. This is the nature of disk-based storage. The more requests that are issued to the device, the higher the latency, whereas typical in-memory caching does not respond this way.

In order to achieve better performance (e.g., lower latency), embodiments described herein selectively (e.g., in cases in which the backing storage for the EC is saturated) bypass the EC and instead complete read operations via a redundant array of independent disks (RAID) subsystem of the storage system. According to one embodiment, one or more performance metrics for the EC backing storage device may be monitored to predict a saturation threshold (e.g., in terms of latency and a corresponding throughput) based on which a saturation point for the EC backing storage device may be selected. As described further below, a storage abstraction layer through which the EC backing storage device is accessed by the file system may be monitored on a periodic basis to allow certain adjustments to be made or tuning to be performed to drive utilization of the EC into the “knee” region or “sweet spot” of a performance (or response) curve of the EC backing storage device. This region, for example, may indicate a shift (or transition) to the effect on the latency as OPS increase. For example, there may be an approximately linear effect on latency up to a first value of OPS. The approximate slope in the first region maybe very small. After that value, the effect may qualitatively change so that even a small number of OPS over that first value would result in a larger increase in the latency (e.g., a steeper slope, exponential relationship, etc.). By identifying this knee region, there is an insight into the saturation level of the EC.

As described further below, implementation and tuning of EC bypass mechanism may be performed to drive utilization of the EC into the knee region, for example, the depth of one or more queues on which in-flight read requests can be buffered at the front-end of an EC lookup may be manipulated based on the current saturation level of the EC backing storage device to limit one or both of the total number of in-flight reads pending for the EC and the number of in-flight large reads pending for the EC.

Various embodiments of the present technology provide for a wide range of technical effects, advantages, and/or improvements to computing systems and components. For example, various embodiments may include one or more of the following technical effects, advantages, and/or improvements: 1) non-routine and unconventional operations to selectively by-pass an EC; 2) non-routine and unconventional operations to dynamically set the depth of one or more queues on which in-flight read requests pending on the EC are buffered; 3) non-routine and unconventional operations to monitor and dynamically identify current saturation values and/or adjust monitoring timers; 4) non-routine and unconventional operations to dynamically tune storage systems to improve read performance; 5) non-routine and unconventional operations to selectively by-pass the EC based a current measure of saturation of a backing storage device for the EC and/or on amount of data associated with read requests; 6) non-routine and unconventional operations to identify qualitative behavior changes to predicted (or historical) latency response due to volume of operations; 7) dynamically setting queue depth to throttle the number of concurrent read operations (large or small) that can hit the EC at once; and 8) use of a second queue, a large request queue, to limit the amount of IOPS that can be used by large reads and thus reserving IOPS for small reads.

In the following description, numerous specific details are set forth in order to provide a thorough understanding of embodiments of the present disclosure. It will be apparent, however, to one skilled in the art that embodiments of the present disclosure may be practiced without some of these specific details. In other instances, well-known structures and devices are shown in block diagram form.

### Terminology

Brief definitions of terms used throughout this application are given below.

A “computer” or “computer system” may be one or more physical computers, virtual computers, or computing devices. As an example, a computer may be one or more server computers, cloud-based computers, cloud-based cluster of computers, virtual machine instances or virtual machine computing elements such as virtual processors, storage and memory, data centers, storage devices, desktop computers, laptop computers, mobile devices, or any other special-purpose computing devices. Any reference to “a computer” or “a computer system” herein may mean one or more computers, unless expressly stated otherwise.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

The terms “component”, “module”, “system,” and the like as used herein are intended to refer to a computer-related entity, either software-executing general-purpose processor, hardware, firmware and a combination thereof. For example, a component may be, but is not limited to being, a process running on a hardware processor, a hardware processor, an object, an executable, a thread of execution, a program, and/or a computer. By way of illustration, both an application running on a server and the server can be a component. One or more components may reside within a process and/or thread of execution, and a component may be localized on one computer and/or distributed between two or more computers. Also, these components can be executed from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

As used herein a “cloud” or “cloud environment” broadly and generally refers to a platform through which cloud computing may be delivered via a public network (e.g., the Internet) and/or a private network. The National Institute of Standards and Technology (NIST) defines cloud computing as “a model for enabling ubiquitous, convenient, on-demand network access to a shared pool of configurable computing resources (e.g., networks, servers, storage, applications, and services) that can be rapidly provisioned and released with minimal management effort or service provider interaction.” P. Mell, T. Grance, The NIST Definition of Cloud Computing, National Institute of Standards and Technology, USA, 2011. The infrastructure of a cloud may cloud may be deployed in accordance with various deployment models, including private cloud, community cloud, public cloud, and hybrid cloud. In the private cloud deployment model, the cloud infrastructure is provisioned for exclusive use by a single organization comprising multiple consumers (e.g., business units), may be owned, managed, and operated by the organization, a third party, or some combination of them, and may exist on or off premises. In the community cloud deployment model, the cloud infrastructure is provisioned for exclusive use by a specific community of consumers from organizations that have shared concerns (e.g., mission, security requirements, policy, and compliance considerations), may be owned, managed, and operated by one or more of the organizations in the community, a third party, or some combination of them, and may exist on or off premises. In the public cloud deployment model, the cloud infrastructure is provisioned for open use by the general public, may be owned, managed, and operated by a cloud provider (e.g., a business, academic, or government organization, or some combination of them), and exists on the premises of the cloud provider. The cloud service provider may offer a cloud-based platform, infrastructure, application, or storage services as-a-service, in accordance with a number of service models, including Software-as-a-Service (SaaS), Platform-as-a-Service (PaaS), and/or Infrastructure-as-a-Service (IaaS). In the hybrid cloud deployment model, the cloud infrastructure is a composition of two or more distinct cloud infrastructures (private, community, or public) that remain unique entities, but are bound together by standardized or proprietary technology that enables data and application portability (e.g., cloud bursting for load balancing between clouds).

As used herein “ephemeral storage” or an “ephemeral disk” generally refers to volatile temporary storage that is physically attached to the same host on which a compute instance is running and which is present during the running lifetime of the compute instance. The “ephemeral” qualifier refers to the fact that the locally attached device is not exclusive to the compute instance, thus when the compute instance changes physical hosts (as it is common in cloud-based environments), the data that the instance stored on the ephemeral device is lost. Ephemeral storage may represent one or more internal or external hard-disk drives (HDDs and/or solid-state drives (SSDs) of the physical host that are directly attached (i.e., without going through one or more intermediate devices of a network) to the physical host though an interface (e.g., Small Computer System Interface (SCSI), Serial Advanced Technology Attachment (SATA), Serial-Attached SCSI (SAS), FC or Internet SCSI (iSCSI)). Ephemeral storage is not networked. That is, there are no connections through Ethernet or FC switches as is the case for network-attached storage (NAS) or a storage area network (SAN). Non-limiting examples of ephemeral storage include an Elastic Compute Cloud (EC2) instance store in the context of Amazon Web Services (AWS), an ephemeral operating system (OS) disk in the context of Microsoft Azure, and ephemeral disks (local SSD) in the context of Google Cloud Platform (GCP).

As used herein, a “large read request” or simply a “large read” generally refers to a request to retrieve an amount of data meeting or exceeding a predefined or configurable large read threshold. In one embodiment, the predefined or configurable threshold for being considered a large read is 32,768 bytes (32 kibibytes (KiB)) or eight 4 KiB data blocks. In other embodiments, the predetermined or configurable large read threshold may be smaller (e.g., 16,384 bytes (16 KiB) or four 4 KiB data blocks), larger (e.g., 65,536 bytes (64 KiB) or sixteen 4 KiB data blocks), or somewhere in between, for example, depending upon compression and/or other factors.

As used herein, a “saturation point” generally refers to a point on a performance curve (defined by latency and OPS) of a storage device at which the storage device is being utilized to its maximum capacity without incurring an undesired level of performance degradation. For example, a storage device may be said to be operating at its saturation point when the slope of a line between two measurements (e.g., a current sample and a previous sample) on the observed or derived performance curve (e.g., based on monitoring of read completion) exceeds a predefined or configurable saturation threshold. In various examples described herein a default for this predefined or configurable saturation threshold is equivalent to 20 Mebibytes (MiB)/second(s) throughput per millisecond (ms) of latency or 5,120 OPS/ms for 4 KiB operations. For a NVMe based local storage, a minimum latency threshold of 2 ms and maximum latency threshold less than 10 ms are appropriate, whereas for a spinning disk, a minimum latency threshold of on the order of 20 ms and a maximum latency threshold of on the order of 50 ms may be more appropriate.

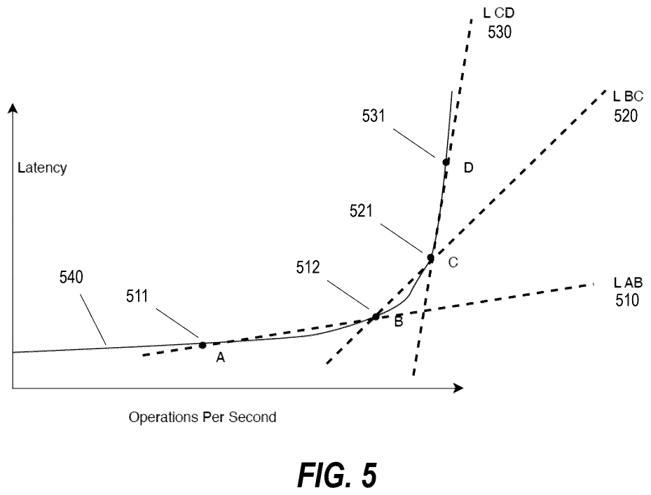

As used herein, a “knee” region or “sweet spot” of a performance curve of a storage device generally refers to a region containing the saturation point. The knee region is bounded by an area below the saturation point (where a large number of OPS can be obtained with small increases in latency) and the area above the saturation point (where a small number of OPS are obtained with large increases in latency). As shown and described with reference to FIG. 5, for example: line AB (LAB) 510 represents a line on a “flat” portion of the performance curve 540. The slope of LAB 510 is lower (or higher inverse slope) than the saturation threshold (small Δlatency->big ΔOPS). Meanwhile, in the same figure, line CD (LCD) 530 represents a line on a “steep” portion of the performance curve. The slope of LCD 530 is higher (or lower inverse slope) than the saturation threshold (big Δlatency->small ΔOPS). The area between the “flat” and the “steep” regions in FIG. 5 is an example of a knee region, where the curve transitions from small slope to large slope. The transition can have a gradual, rounded shape, as shown in some examples herein, but it can also take the form of a sharp angle. For example, at the knee, the saturation threshold may change from thousands of MiB/s/ms into single-digit MiB/s/ms. In various examples described herein, a saturation threshold is chosen to facilitate selection of a saturation point that falls between the flat and steep regions (or at the knee of the performance curve). The knee region can generally be thought of as a zone in the performance curve in which the benefit (e.g., throughput or OPS) is maximized (extracting as many OPS as possible from the “flat” region of the curve, as far to the right as possible on the graph) and the cost (e.g., latency) is minimized (expending the least amount of latency in the “steep” part, as low as possible on the graph).

### Example Operating Environment

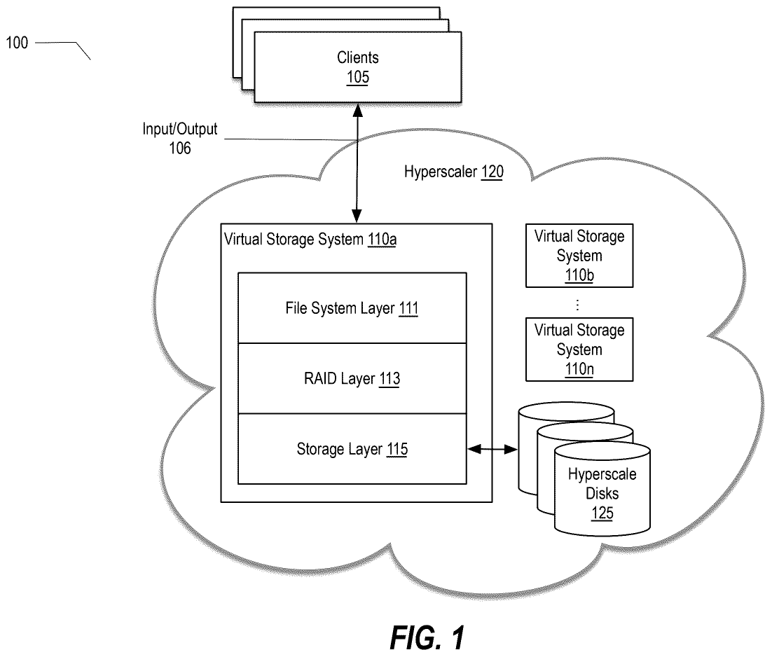

FIG. 1 is a block diagram illustrating an environment 100 in which various embodiments may be implemented. In various examples described herein, a virtual storage system 110a (which may be considered exemplary of individual virtual storage systems 110a-n operating as a cluster and collectively representing a distributed storage system) may be run (e.g., on a VM or as a containerized instance, as the case may be) within a public cloud provided by a public cloud provider (e.g., hyperscaler 120). In the context of the present example, the virtual storage system 110a makes use of storage (e.g., hyperscale disks 125) provided by the hyperscaler, for example, in the form of solid-state drive (SSD) backed or hard-disk drive (HDD) backed disks. The cloud disks (which may also be referred to herein as cloud volumes, storage devices, or simply volumes or storage) may include persistent storage (e.g., disks) and/or ephemeral storage (e.g., disks).

The virtual storage system 110a may present storage over a network to clients 105 using various protocols (e.g., small computer system interface (SCSI), Internet small computer system interface (ISCSI), fibre channel (FC), common Internet file system (CIFS), network file system (NFS), hypertext transfer protocol (HTTP), web-based distributed authoring and versioning (WebDAV), or a custom protocol. Clients 105 may request services of the virtual storage system 110 by issuing Input/Output requests 106 (e.g., file system protocol messages (in the form of packets) over the network). A representative client of clients 105 may comprise an application, such as a database application, executing on a computer that “connects” to the virtual storage system 110 over a computer network, such as a point-to-point link, a shared local area network (LAN), a wide area network (WAN), or a virtual private network (VPN) implemented over a public network, such as the Internet.

In the context of the present example, the virtual storage system 110a is shown including a number of layers, including a file system layer 111 and one or more intermediate storage layers (e.g., a RAID layer 113 and a storage layer 115). These layers may represent components of data management software (not shown) of the virtual storage system 110. The file system layer 111 generally defines the basic interfaces and data structures in support of file system operations (e.g., initialization, mounting, unmounting, creating files, creating directories, opening files, writing to files, and reading from files). A non-limiting example of a file system that may implement the file system layer 111 is the Write Anywhere File Layout (WAFL® file system), which represents a Copy-on-Write file system. The WAFL® file system is a component or layer of ONTAP® software available from NetApp, Inc. of San Jose, CA.

The RAID layer 113 may be responsible for encapsulating data storage virtualization technology for combining multiple hyperscale disks 125 into RAID groups, for example, for purposes of data redundancy, performance improvement, or both. The storage layer 115 may include storage drivers for interacting with the various types of hyperscale disks 125 supported by the hyperscaler 120. Depending upon the particular implementation the file system layer 111 may persist data to the hyperscale disks 125 using a persistent storage subsystem (not shown), including one or both of the RAID layer 113 and the storage layer 115.

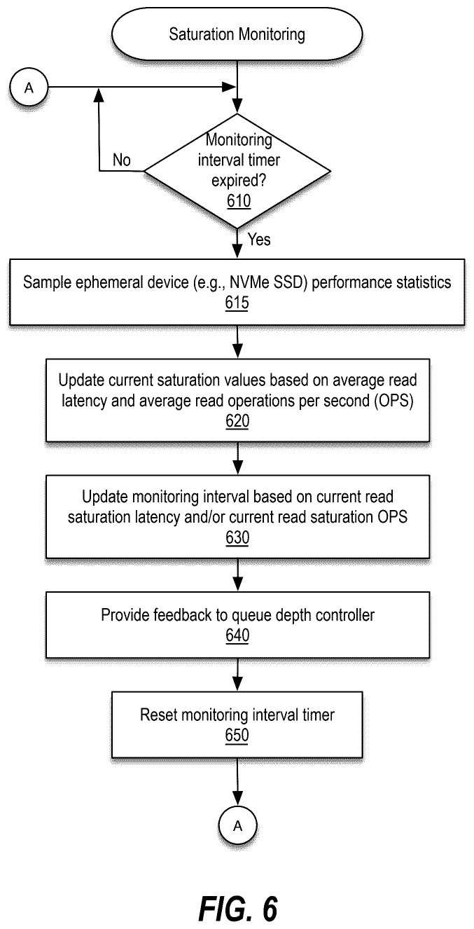

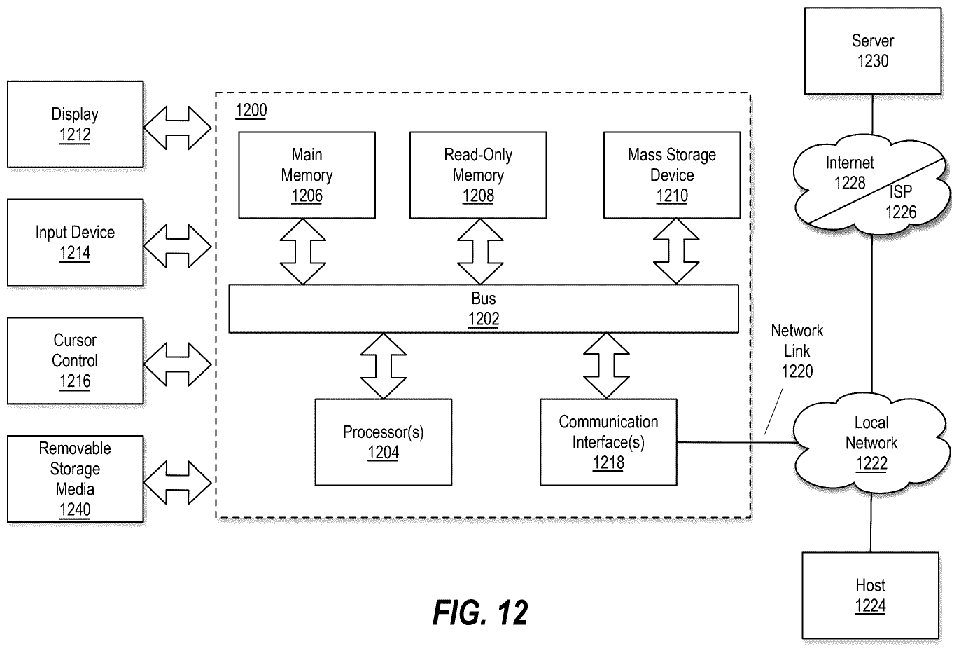

The various layers and functional components described herein, and the processing described below with reference to the flow diagrams of FIGS. 6 and 8-11 may be implemented in the form of executable instructions stored on a machine readable medium and executed by one or more processing resource (e.g., one or more microcontroller, one or more microprocessors, one or more central processing unit core(s), one or more application-specific integrated circuits (ASICs), one or more field programmable gate arrays (FPGAs), and the like) and/or in the form of other types of electronic circuitry. For example, the processing may be performed by one or more virtual or physical computer systems of various forms (e.g., servers, blades, network storage systems or appliances, and storage arrays, such as the computer system described with reference to FIG. 12 below.

### Example Host

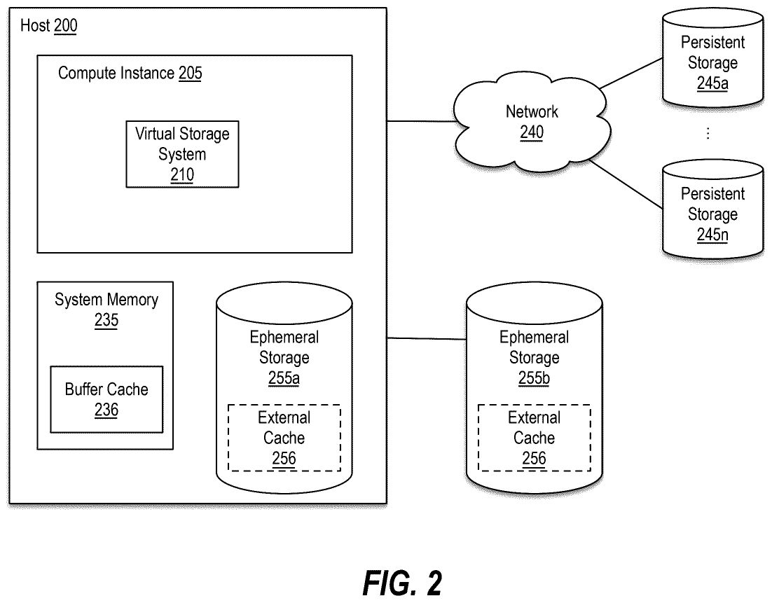

FIG. 2 is a block diagram conceptually illustrating a host 200 of a cloud environment in accordance with an embodiment of the present disclosure. In the context of the present example, host 200 may represent a physical host (e.g., a server computer system) on which a compute instance 205 (e.g., a container or a VM) may be run in a cloud environment provided by a cloud service provider (e.g., hyperscaler 120).

In the context of the present example, virtual storage system (e.g., virtual storage system 210, which may be analogous to one of virtual storage systems 110a-n) operable within compute instance 205 implements two levels of read caching, including a buffer cache 236 within system memory 235 and an external cache (EC) 256 within ephemeral storage (e.g., ephemeral storage 255a or 255b). The ephemeral storage may represent local storage of the host 200 (e.g., ephemeral storage 255a) that is available for use by the compute instance 205 or may represent direct attached storage (e.g., ephemeral storage 255b). Ephemeral storage may represent direct-attached-storage (DAS) to host 200 in the form of one or more internal (e.g., ephemeral storage 255a) and/or external (e.g., ephemeral storage 255b) storage devices, such as HDDs and/or SSDs (e.g., NVMe SSD), to host 200. In the context of the present example, ephemeral storage may be directly attached to host 200 through a physical host interface (e.g., SCSI, SATA, or SAS)). That is, the ephemeral storage is not networked and traffic exchanged between the host 200 and the ephemeral storage does not pass through any intermediate network devices associated with the cloud environment.

As noted above, the buffer cache 236 may represent a first-level cache in which modified data is temporarily buffered until a CP is performed to flush the modified data to persistent storage (e.g., persistent storage 245a-n), which may be in the form of one or more network attached hyperscale disks (e.g., hyperscale disks 125) representing HDDs and/or SSDs) that are indirectly attached to the host 200 via a network (e.g., network 240) within the cloud environment. Hot data may be retained in the buffer cache 236 to enhance read performance and lower priority data may be evicted to the EC 256, representing a second-level cache that stores overflow or evictions from the buffer cache 236.

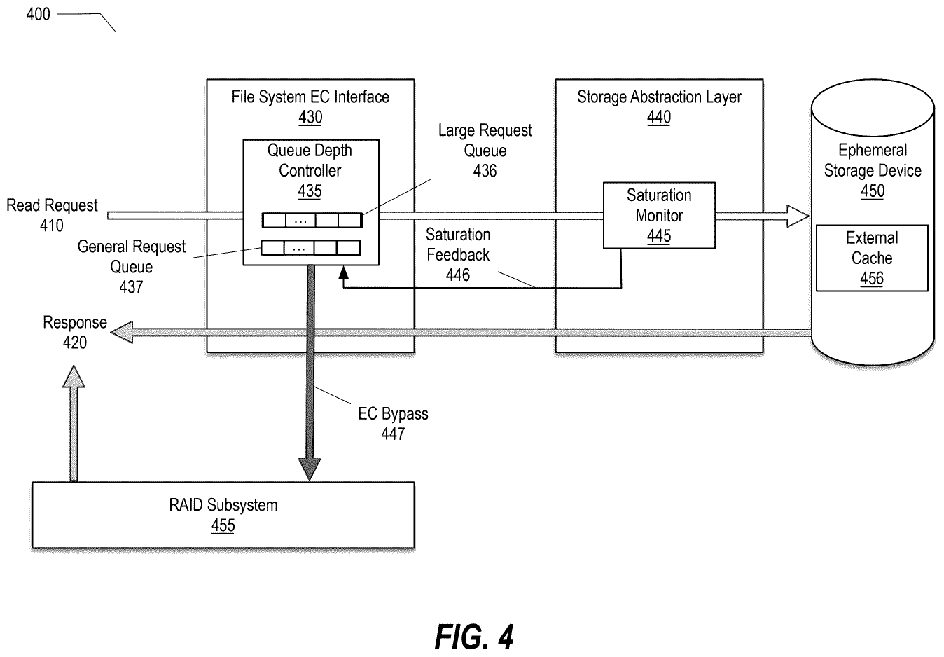

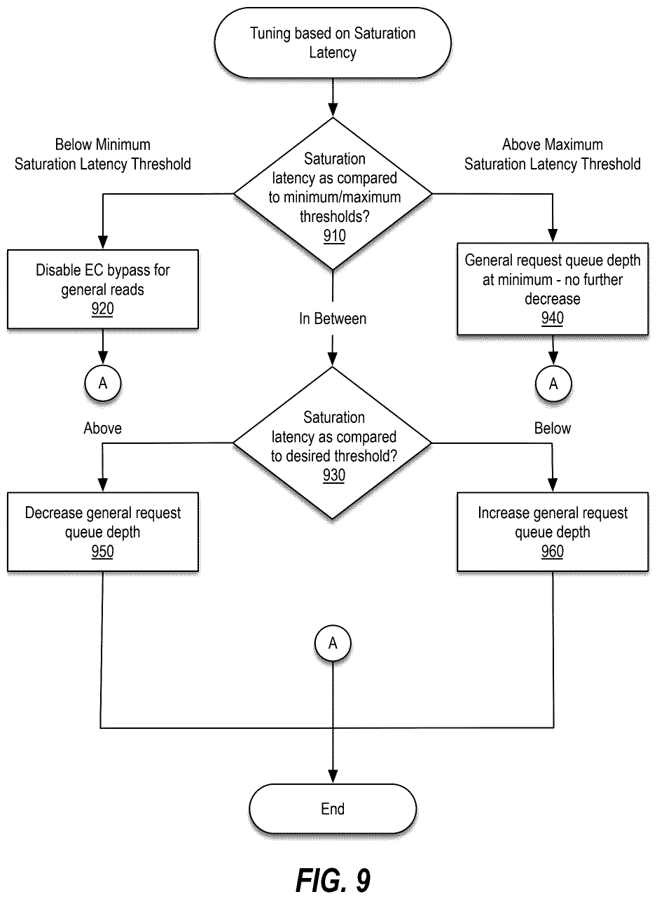

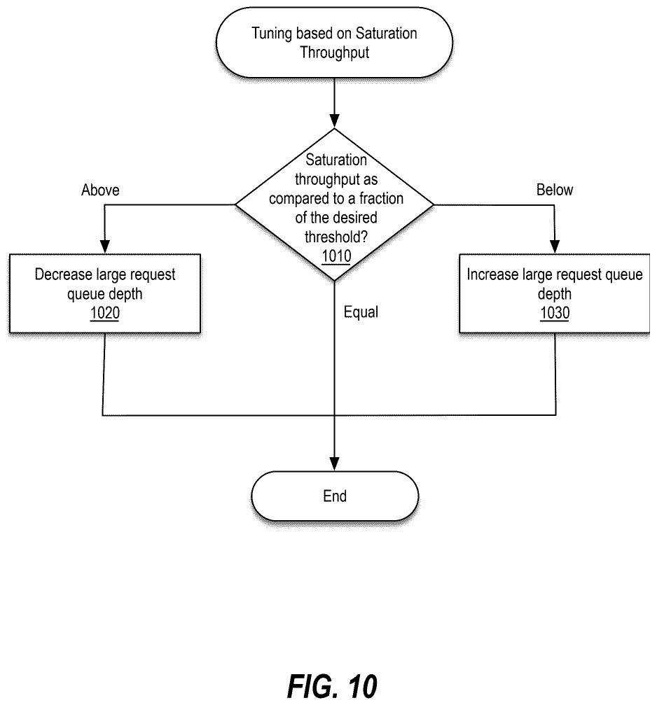

As described further below, for example, with reference to FIGS. 4, 6, and/or 8-11, in various embodiments, in an attempt to improve read performance, virtual storage system may selectively bypass EC lookups when serving read operations based on monitoring one or more performance metrics for the backing storage (e.g., ephemeral storage 255a or 255b) of the external cache 256 and instead perform read operations via a RAID subsystem (e.g., RAID layer 113) of the virtual storage system. In some embodiments, EC bypass is controlled at least in part by manipulating the depth of one or more queues fronting the EC lookup. For example, as described further below with reference to FIGS. 9-10, the depth of a one or more request queues holding in-flight read operations awaiting performance of EC lookup may be increased or decreased as appropriate based on one or more current measures of saturation of the EC backing storage device as compared to one or more desired saturation thresholds (e.g., representing the sweet spot of a performance curve of the EC backing storage device).

### Example Performance Profiles

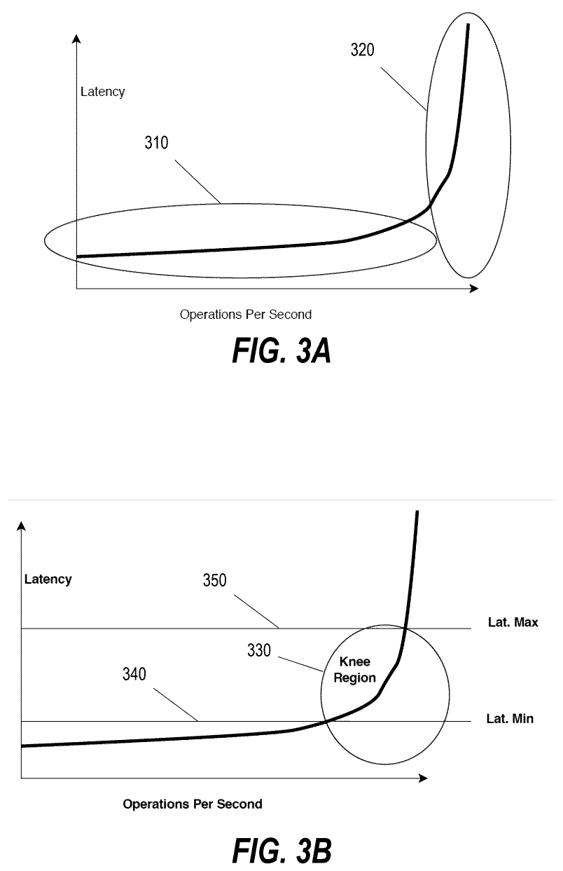

FIG. 3A is a graph depicting an example of a performance profile for external cache reads, which follows the profile for the backing storage device, with latency plotted against operations per second (OPS) including a first region 310 in which latency remains relatively constant with increasing OPS and a second region 320 in which latency increases sharply with small increases in OPS.

In various examples described herein, an EC (e.g., EC 256) is populated with data that is evicted from the buffer cache (e.g., buffer cache 236). Whether the data is read from the buffer cache, EC, or persistent storage (e.g., persistent storage 245a-n via the RAID subsystem), the data is the same, only the latency of the read operation varies. Cache blocks may be managed in units of 4 KiB (4,096 bytes). For each 4 KiB unit, the EC may also maintain 64 bytes of metadata (checksum and other data). In such an example, the EC issues two operations to read data from ephemeral storage (e.g., ephemeral storage 255a or 255b)—one for 4 KiB and one for 64 bytes. Each hyperscaler has different 4 KiB read entitlements in terms of throughput (e.g., expressed in terms of IOPS). That is, hyperscalers generally limit the available throughput (e.g., read throughput, write throughput, and/or total throughput) of backing storage devices they make available to cloud resource consumers.

When read latency is plotted against operations per second (OPS), the curve looks like that depicted in FIG. 3A, with a somewhat flat region (e.g., first region 310) where latency remains somewhat constant with increasing OPS, and a steep region (e.g., second region 320) where latency increases sharply with small increases in offered IOPS

FIG. 3B is a graph depicting the example performance profile of FIG. 3A with a knee region 330 (or sweet spot) identified in accordance with an embodiment of the present disclosure. The knee region 330 may represent a region of the performance profile in which there exists an acceptable tradeoff of a measure of throughput per unit of latency. For example, the keen region 300 may represent a region of the performance profile bounded at the upper end by a predefined or configurable saturation threshold in which throughput of approximately 20 MiB/s may be achieved per 1 millisecond (ms) of latency. It is to be noted, depending on the particular implementation, this saturation threshold may be defined in a number of ways, for example, the saturation threshold employed could be a slope of the performance curve, a distance from (or proximity to) the sweet spot, a maximum latency, a maximum IOPS, and/or a combination of various of the foregoing measurements.

According to one embodiment, the current saturation level of the EC (e.g., EC 256) and/or the size (e.g., in blocks or bytes) of the in-flight read requests to be queued thereon (pending their respective EC lookups) may cause the queue depth controller to manipulate the depth of one or more EC lookup request queues (e.g., a general request queue and/or a large request queue) in an attempt to drive utilization of ephemeral storage (e.g., ephemeral storage 255a or 255b) that serves as the backing storage for the EC into the sweet spot (e.g., the knee region 330) of the performance curve for the ephemeral storage device at issue.

As described further below with reference to FIG. 9, in one embodiment, when a measure of saturation latency (e.g., the average latency of all reads (EC lookups) performed within a given monitoring interval performed by a saturation monitor (e.g., saturation monitor 445)) is below a predefined or configurable minimum threshold (e.g., latency minimum 340), which may be on the order of 2 milliseconds (ms), EC bypass may be disabled to allow reads to make use of EC lookups. When the measure of saturation latency is in between the predefined or configurable minimum threshold and a predefined or configurable maximum threshold (e.g., latency maximum 350), which may be on the order of 6 ms, the depth of an EC lookup queue (e.g., a general request queue 437) may be manipulated to drive utilization of the EC into the knee region (e.g., knee region 330). In one embodiment, the general queue depth controls how many concurrent total reads (large reads and small reads) reach the EC backing storage device.

As described further below with reference to FIG. 10, in one embodiment, when a measure of saturation throughput (e.g., the average throughput (e.g., OPS) of read operations performed within a given monitoring interval performed by the saturation monitor is above or below a throughput threshold (e.g., saturation throughput threshold 727), the depth of a separate EC request queue (e.g., large request queue 436), maintained solely for large reads, may be manipulated to limit utilization of available throughput of the EC backing storage device by large reads, thereby preserving some portion (e.g., 50%) of the available throughput for use by small reads. In one embodiment, a combination of both the large request queue and the general request queue is used to control how many concurrent large reads reach the EC backing storage device, thereby increasing the chances for large read requests of larger size bypassing the EC.

### Example External Cache Bypass Mechanism

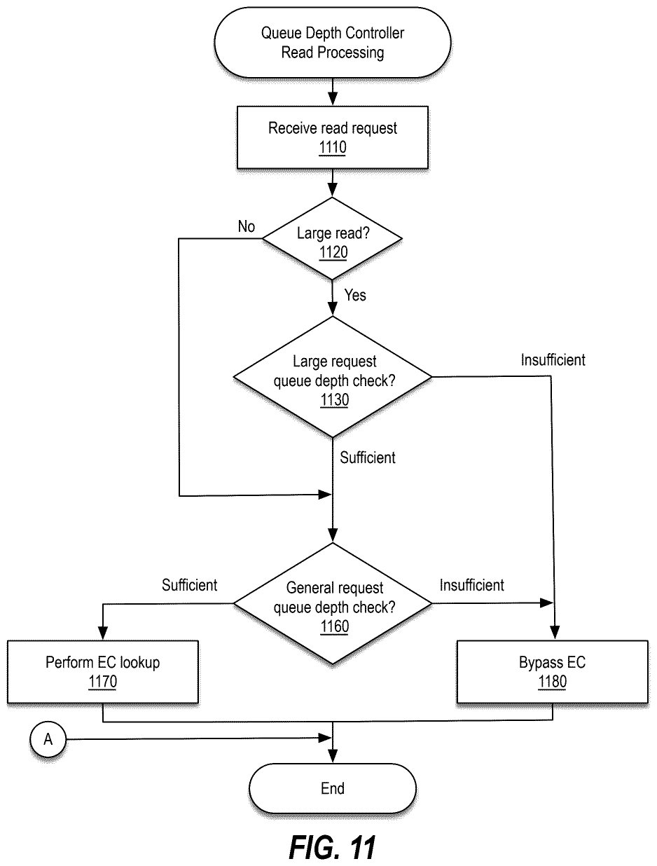

FIG. 4 is a block diagram illustrating various functional components of an external cache (EC) bypass mechanism 400 in accordance with an embodiment of the present disclosure. In the context of the present example, the EC bypass mechanism 400 of a virtual storage system (e.g., one of virtual storage systems 110a-n or virtual storage system 210) is composed of the following functional components: (i) a mechanism (e.g., a saturation monitor 445) to detect and quantify the level of saturation for the EC backing storage device (e.g., ephemeral storage device 450, which may be analogous to one of ephemeral storage 255a or 255b); (ii) a general restriction implemented by a queue depth controller 435 to limit the number of outstanding requests on the EC backing storage device, based on the measured saturation level; and (iii) a scheme to prioritize requests into the EC by size, with requests of larger size having a higher chance of getting bypassed. A non-limiting example of a prioritization approach is described further below with reference to FIG. 11.

In the context of the present example, the queue depth controller 435 is shown as a module implemented within a file system EC interface 430. The file system EC interface 430 may represent a component of a file system (e.g., file system layer 111) responsible for handling read requests (e.g., read request 410) for which a look up in the buffer cache has failed and for which a determination is now to be made regarding whether to perform an EC lookup in the EC 456 (which may be analogous to EC 256) or whether to bypass the EC lookup and instead perform the read via a RAID subsystem 455 (which may be analogous to RAID layer 113) of the virtual storage system. In one embodiment, read requests may represent the output from a read-ahead mechanism (e.g., that combines multiple, small reads into larger sequential reads).

The queue depth controller 435 may enable/disable EC bypass (e.g., performance of EC bypass 447) and/or manipulate the depth of one or more EC lookup request queues (or EC lookup queues) (e.g., a general request queue 437 and a large request queue 436) based on saturation feedback 446 provided by the saturation monitor 445. According to one embodiment, as part of an EC lookup process, and before performing any EC lookup operations for a given read request, the queue depth controller 435 may either queue the given read request for performance of an EC lookup within external cache 456 stored within ephemeral storage device 450 or cause the given read request to take the EC bypass 447 path without performance of an EC lookup. In the case of the read request triggering an EC lookup within the ephemeral storage device 450, a response 420 may be returned to the client (e.g., one of clients 105) via a storage abstraction layer 440 (which, depending on the particular implementation, may represent a file system driver or may be implemented as part of a storage layer (e.g., storage layer 115) and the file system EC interface 430. When the read request takes the EC bypass path 447, the response 420 is returned by the RAID subsystem 455.

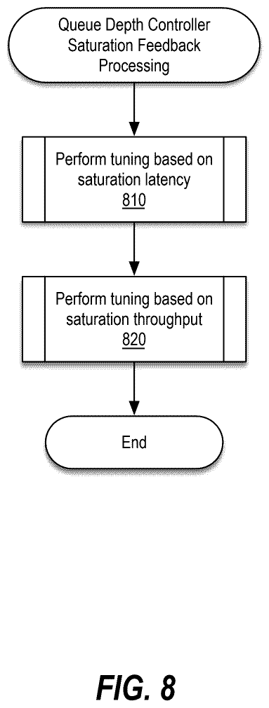

In the context of the present example, the queue depth controller 435 is shown maintaining two EC lookup request queues (e.g., a general request queue 437 and a large request queue 436). The general request queue 437 may be used to limit the total number of in-flight read requests (regardless of size—small or large) pending on the EC (or awaiting performance of respective EC lookups). As described further below with reference to FIG. 8, the depth (or number of entries) of the general request queue 437 may be increased or decreased as appropriate based on saturation latency of the ephemeral storage device 450.

Hyperscalers generally limit the available throughput (e.g., one or more of read throughput, write throughput, and total throughput) of backing storage devices they make available to cloud resource consumers. The large request queue 436 may be used to limit the available throughput of the ephemeral storage device 450 utilized by large reads, thereby preserving some portion of the available throughput for small reads. For example, the initial queue depth of the large request queue 436 may be set so as to limit utilization of the available throughput to a portion (e.g., on the order of about 50%). As described further below with reference to FIG. 9, the depth (or number of entries) of the large request queue 436 may be increased or decreased as appropriate based on saturation throughput of the ephemeral storage device 450. In one embodiment, each entry of the respective EC lookup request queues corresponds to one block of a read request pending an EC lookup within the EC 456.

In this example, the saturation monitor 445 is shown as a module implemented within the storage abstraction layer 440, which represents an abstraction layer for the file system EC interface 430 to interact with the ephemeral storage device 450. As described further below with reference to FIG. 6, the saturation monitor 445 may monitor read completion times (e.g., for EC lookups) and/or periodically sample performance statistics relating to the ephemeral storage device 450 and provide saturation feedback 446 to the queue depth controller 435.

### Example Saturation Monitoring and Saturation Point Detection

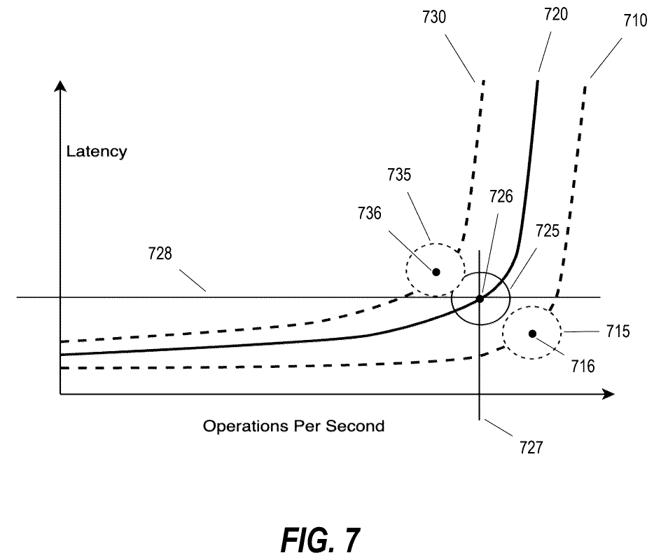

FIG. 5 is a graph depicting an example of a performance profile or curve (e.g., performance curve 540) for external cache reads and illustrating slopes of various lines through sample data points inside and outside of the knee region in accordance with an embodiment of the present disclosure. In some embodiments, a saturation point (and/or associated saturation thresholds of the encompassing knee region) may be updated based on the current latency and OPS averages, for example, by comparing them to the current saturation latency and OPS values, and determining whether the saturation point should be updated. As described further below with reference to FIG. 7, as the read latency profile of a given backing storage device is not static, for example, as a result of being affected by other operations on the given backing storage device (e.g., write operations), the saturation point may move as more or fewer writes are concurrently performed with reads (e.g., EC lookups) for the given backing storage device.

In one embodiment, an ephemeral storage device (e.g., ephemeral storage 255a or 255b) representing a backing store for the EC (e.g., external cache 256 or 456) may be said to have reached saturation when the increase in latency required to increase the number of OPS performed is above a certain predetermined or configurable saturation latency vs. OPS threshold, which as noted above may be defined in a number of ways.

In the context of the present example, initially, latency/OPS may be sampled at point A 511, for example, by a saturation monitor (e.g., saturation monitor 445). A second latency/OPS sample may be taken at point B 412. The increase in latency (lat B−lat A) divided by the increase in OPS (OPS B−OPS A) represents the slope of line AB (LAB) 510. The next sample, going from point B 512 to point C 521 creates line BC (LBC) 520. The slope of LBC 520 is clearly larger than the slope of LAB 510, meaning that the increase in latency compared to the increase in OPS for LBC 520 is greater than that in LAB 510.

Assuming for sake of example, that the saturation latency vs. OPS threshold is equal to the slope of LBC 520 in the graph of FIG. 5, the following may be observed:
Point B 512 is not a saturation point, as getting to point B 512 requires a line whose slope is below the threshold.
Point C 521 is the saturation point, as getting from point B 512 to point C 521 requires a line that equals the threshold.
Point D 531 is beyond the saturation point, as getting to point D 531 requires a line CD (LCD) 530 that exceeds the threshold.

In this example, the only way to increase both the saturation latency and saturation OPS point is to reach a saturation point along a line where the slope is at or below the threshold.

For purposes of device saturation, a threshold of 5,120 OPS/ms or ˜20 MiB/second for 4 KiB EC operations (e.g., EC reads (or EC lookups) and EC writes) may be set as a default. In some embodiments, this threshold may be adjustable, for example, through saturation point update logic, for example, as described with reference to FIGS. 6 and 7.

FIG. 6 is a flow diagram illustrating operations for performing saturation monitoring in accordance with an embodiment of the present disclosure. The saturation monitoring described with reference to FIG. 6 may be performed on a periodic basis by a saturation monitor (e.g., saturation monitor 445) to provide saturation feedback (e.g., saturation feedback 446) for use by an EC lookup queue depth controller (e.g., queue depth controller 435).

At decision block 610, it is determined whether a monitoring interval timer (e.g., on the order of between approximately 1 and 10 seconds) has expired. If so, a new monitoring cycle is performed by continuing with block 615; otherwise, processing loops back to decision block 610 to await expiration of the monitoring interval timer. As explained further below, in one embodiment, depending on the proximity of the sampled latency/OPS to the sweet spot or the saturation threshold, the interval between monitoring cycles may be increased or decreased as appropriate.

At block 615, performance statistics/metrics of the ephemeral storage (e.g., ephemeral storage 255a or 255b) representing the backing storage for the EC (e.g., EC 256 or 456) may be sampled. These performance statistics/metrics may be sampled from a storage abstraction layer (e.g., storage abstraction layer 440) that provides an interface to the ephemeral storage and may include tracking completions of reads performed on the EC to determine the latency of reads performed since the last monitoring interval and OPS (or throughput). Depending on the particular embodiment, OPS may be tracked separately for small reads and large reads

At block 620, saturation point update logic may be performed to update the current saturation values based on the average read latency and average read OPS from the samples obtained in block 610. For example, as noted below with reference to FIG. 7, the performance profile for EC reads (EC lookups) is not static and may be affected by other operations occurring within the storage system (e.g., write operations to the EC resulting from evictions from the buffer cache (e.g., buffer cache 236)).

At block 630, the monitoring interval may be updated based on current read saturation latency and/or current read saturation OPS. For example, as the samples get closer to the saturation threshold, it may be helpful to decrease the monitoring interval to facilitate performance of one or more additional monitoring cycles before the saturation threshold is reached. Similarly, when the samples are sufficiently distant from the saturation threshold, the frequency of the monitoring cycles may be decreased by increasing the monitoring interval. In other examples, the saturation latency percentage represented by the current saturation latency and/or the read saturation OPS percentage represented by the current read saturation OPS may cause an increase or decrease to the monitoring interval.

At block 640, the saturation feedback may be provided to the queue depth controller. Depending on the particular implementation, the saturation feedback may be provided in various forms, including, but not limited to, one or more of an absolute saturation latency (e.g., a read latency in terms of a given unit of time, such as microseconds (μs) or milliseconds (ms)), a change in saturation latency (e.g., since feedback was last provided), an absolute saturation throughput (e.g., in terms of read OPS), a change in saturation throughput, a saturation latency percentage, and a read saturation OPS percentage (e.g., in which 100% represents the sweet spot or the saturation point). Depending on the particular implementation, saturation throughput may be tracked and reported separately for small reads and large reads, for example, to facilitate preventing large reads from using all available throughput of the EC backing storage device.

Assuming the slope of the line (e.g., LBC 520) between sampling intervals represents the saturation threshold (e.g., the acceptable tradeoff between throughput and latency), in one embodiment, during each iteration, a delta latency (e.g., a latency calculated between the average of the last sampling interval and the average of the current sampling interval) and a delta throughput (between the average of the last sampling interval and the average of the current sampling interval) may be calculated. The current slope of the observed (or derived) performance curve may then be calculated by dividing delta latency by delta throughput. The current slope may then be compared to the saturation threshold (e.g., slope of LBC 520). In this example, when the current slope is less than the saturation threshold, the queue depth controller may cause EC lookups to be performed to serve reads and when the current slope is greater than the saturation threshold, the queue depth controller may perform EC-Bypass (e.g., avoid performing EC lookups and instead read directly from the RAID subsystem)

At block 645, the monitoring interval timer is reset based on the current monitoring interval, for example, which may have been updated in block 630.

FIG. 7 is a graph depicting an example of the dynamic nature of the performance profile for external cache reads in accordance with an embodiment of the present disclosure. It is to be appreciated the latency profile of the EC backing storage device (e.g., ephemeral storage device 450) is not static as the read latency is affected by other operations taking place within the storage system (e.g., one of virtual storage systems 110a-c or 210). For example, write operations resulting from evictions from the buffer cache (e.g., buffer cache 236) may concurrently be performed to the EC (e.g., EC 256 or 456).

Assuming a baseline latency profile represented by curve 720 and having a saturation point at 726 (e.g., defined by a desired latency threshold 728 and a corresponding saturation throughput (e.g., OPS) threshold 727) within an associated knee region 725, this graph illustrates the impact of increased and decreased performance of concurrent writes to the EC backing storage device. When there are more writes occurring, there will be more latency for the same level of OPS. As such, in the present example, when more writes are occurring, a newly computed saturation point may move to saturation point 736 within an associated knee region 735 and on a new latency profile represented by curve 730 (lowering the saturation OPS and causing the saturation point update logic, for example, in block 620 of FIG. 6 to increase the saturation latency and decrease OPS until the new threshold is achieved). When there are fewer writes occurring, there will be a decrease in latency for the same level of OPS. As such, in the present example, when fewer writes are occurring, a newly computed saturation point may move to saturation point 716 within an associated knee region 715 and on a new latency profile represented by curve 710 (lowering the saturation latency and causing the saturation point update logic to decrease the saturation latency and increase OPS until the new threshold is achieved).

### Example Queue Depth Controller Processing

FIG. 8 is a flow diagram illustrating operations for performing saturation feedback processing by an EC queue depth controller in accordance with an embodiment of the present disclosure. The processing described with reference to FIG. 8 may be performed by a queue depth controller (e.g., queue depth controller 435) implemented by a file system (e.g., file system layer 111) of a virtual storage system (e.g., one of virtual storage systems 110a-n or virtual storage system 210), for example, within a file system EC interface (e.g., file system EC interface 430).

At block 810, the queue depth controller performs tuning based on saturation latency. A current measure of saturation latency relating to a backing storage device (e.g., ephemeral storage device 450) of an EC (e.g., EC 256 or 456) implemented by the file system may be provided to the queue depth controller as part of saturation feedback (e.g., saturation feedback 446) received from a saturation monitor (e.g., saturation monitor 445). In various embodiments described herein, the saturation latency may be used to, among other things, increase or decrease a depth of an EC lookup request queue (e.g., general request queue 437) maintained by the queue depth controller. In one embodiment, the tuning seeks to drive utilization of the EC into the “knee region” (e.g., keen region 330) or “sweet spot” or otherwise toward the saturation point (e.g., one of saturation points 715, 725, 735) of an observed or derived performance curve (e.g., performance curve 540, 710, 720, or 730) of the EC backing storage device. A non-limiting example of tuning that may be performed by the queue depth controller based on saturation latency is described further below with reference FIG. 9.

At block 820, the queue depth controller performs tuning based on saturation throughput. A current measure of saturation throughput relating to the EC may be provided to the queue depth controller as part of saturation feedback (e.g., saturation feedback 446) received from a saturation monitor (e.g., saturation monitor 445). In various embodiments described herein, the saturation throughput may be used to, among other things, increase or decrease a depth of an EC lookup request queue (e.g., large request queue 436) maintained by the queue depth controller. In one embodiment, the tuning seeks to ensure that only a portion (e.g., 50%) of the saturation throughput (e.g., saturation throughput threshold 727) is used for large reads. A non-limiting example of tuning that may be performed by the queue depth controller based on saturation throughput is described further below with reference FIG. 10.

### Example Tuning Based on Saturation Latency

FIG. 9 is a flow diagram illustrating operations for performing tuning based on saturation latency in accordance with an embodiment of the present disclosure. As above, the processing described with reference to FIG. 9 may be performed by a queue depth controller (e.g., queue depth controller 435) implemented by a file system (e.g., file system layer 111) of a virtual storage system (e.g., one of virtual storage systems 110a-n or virtual storage system 210), for example, within a file system EC interface (e.g., file system EC interface 430). In the context of the present example, a queue depth of a general request queue (e.g., general request queue 437) is manipulated or tuned to limit the total number of in-flight read requests (regardless of size—small or large) pending on an EC (e.g., EC 256 or 456) based on a current measure of saturation latency relating to a backing storage device (e.g., ephemeral storage device 450) of the EC.

In one embodiment, an EC bypass mechanism (e.g., EC bypass mechanism 400) may operate in an initial mode or calibration mode until a saturation point is determined by a saturation monitoring process (e.g., the saturation monitoring described with reference to FIG. 6). In the calibration mode, both the queue size (e.g., the depth of the general request queue may have essentially an unlimited depth, thereby allowing all read requests to access the EC. Once the average latency exceeds the minimum threshold (e.g., 2 ms), sampling may begin and continues until a saturation point (e.g., a latency/OPS pair which, compared to the previous sample, exceeds the saturation threshold (e.g., 5,120 Op/sec/ms). After the saturation point is determined, the calibration mode may be exited and a normal runtime mode may be entered in which the queue depth may be set to the current number of outstanding read requests. For example, if there were 1,000 total requests in flight at the time the saturation point was determined, then the depth of the general queue may be set to 1,000.

At decision block 910, the current measure of saturation latency is compared to minimum and/or maximum saturation latency thresholds (e.g., lat. min 340 and lat. max 350). As noted herein, there are various measures of saturation latency. In one example, the average latency of all reads (EC lookups) performed within a given monitoring interval performed by a saturation monitor (e.g., saturation monitor 445) may represent the current measure of saturation latency. When the current saturation latency is below the minimum saturation latency threshold, processing branches to block 920. When the current saturation latency is above the maximum saturation latency threshold, processing branches to block 940. When the current saturation latency is in between the minimum and maximum saturation latency thresholds, processing continues with decision block 930. In one embodiment, the minimum and maximum saturation latency thresholds are predetermined or configurable values and may have default values of approximately 2 milliseconds (ms) and 6 ms, respectively.

At block 920, EC bypass is disabled. According to one embodiment, this may be achieved by the depth of the general queue becoming very large as a result of increasing the depth in block 960 (below). For example, with reference to FIG. 3B, when the current saturation latency is below latency min 340, there is no need for the read at issue to bypass the EC as the data point at issue is not yet in the sweet spot for the EC backing storage device.

At decision block 930, the current saturation latency is compared to a desired saturation latency threshold to determine whether and how a depth of the general queue is to be manipulated. The desired saturation latency threshold may be a predetermined or configurable value representing a saturation point (e.g., one of saturation points 716, 726, or 736) within the sweet spot or knee region (e.g., one of knee regions 715, 725, or 735, respectively) of the current read performance curve (e.g., one of curves 710, 720, or 730) observed for the EC backing storage device based on monitoring of the EC backing storage device. When the current saturation latency is above the desired saturation latency threshold (e.g., desired saturation latency threshold 728), processing continues with block 950. When the current saturation latency is below the desired saturation latency threshold, processing branches to block 960.

At decision block 940, the depth of the general queue is at a minimum so no further decrease in the queue depth is performed.

At block 950, the depth of the general queue is decreased. For example, the current depth of the general queue may be reduced by one or more entries. In one embodiment, each entry of the general queue may correspond to one 4 KiB data block of a read request (e.g., read request 410). According to one embodiment, the queue depth is reduced by the same percentage that the current saturation latency exceeds 100% of the desired saturation latency threshold. So, for example, if the current saturation percentage is 107%, the current queue depth would be reduced by 7%. In practice, single percentage points may be considered negligible, so a minimum quantum of change (e.g., 10%) may be used.

At block 960, the depth of the general queue is increased. For example, the current depth of the general queue may be expanded by one or more entries. According to one embodiment, the queue depth is increased by the same percentage that the current saturation latency is below 100% of the desired saturation latency threshold. So, for example, if the current saturation percentage is 80%, the current queue depth would be increased by 20%. As noted above, in practice, single percentage points may be considered negligible, so a minimum quantum of change (e.g., 10%) may be used.

In this manner, the monitored saturation level may be used to manipulate or tune the queue depth of the general request queue so as to drive utilization of the EC backing storage device into the sweet spot of the device response curve (which may also be referred to herein as a read performance curve or simply a performance curve). For example, the sweet spot may reside:
Below a maximum latency (e.g., lat. max 350), above which the EC backing storage device cannot provide more IOPS without a significant increase in latency; and
Above a minimum latency (e.g., lat. min 340), below which the EC backing storage device can provide all required IOPS at low latency.

Notably, in various examples, above the maximum latency, the queue depth will be very low so as to force most read operations to bypass the EC, thus bringing the latency into the sweet spot, whereas as the latency drops toward the minimum latency, the queue depth will increase to allow more operations (if available) to enter the EC, minimizing bypass.

While in the context of the present example, a depth of a general request queue maintained by the file system on which in-flight small read requests are queued pending performance of respective EC lookups is described as being increased or decreased based on a measure of saturation latency, it is to be appreciated in other examples, other performance measures or metrics associated with the EC backing storage may be used individually or in various combinations.

### Example Tuning Based on Saturation Throughput

FIG. 10 is a flow diagram illustrating operations for performing tuning based on saturation throughput in accordance with an embodiment of the present disclosure. As above, the processing described with reference to FIG. 10 may be performed by a queue depth controller (e.g., queue depth controller 435) implemented by a file system (e.g., file system layer 111) of a virtual storage system (e.g., one of virtual storage systems 110a-n or virtual storage system 210), for example, within a file system EC interface (e.g., file system EC interface 430). In the context of the present example, a queue depth of a large request queue (e.g., large request queue 436) is manipulated or tuned to place a throughput limit (e.g., a percentage of total available throughput associated with a backing storage device (e.g., ephemeral storage device 450) of an EC (e.g., EC 256 or 456)) on large reads pending on the EC, thereby increasing the chances of large reads to bypass the EC and reserving some portion of the available throughput for performance of small reads (when available).

As noted above, in one embodiment, an EC bypass mechanism (e.g., EC bypass mechanism 400) may operate in an initial mode or calibration mode until a saturation point is determined by a saturation monitoring process (e.g., the saturation monitoring described with reference to FIG. 6). After the saturation point is determined, the calibration mode may be exited and a normal runtime mode may be entered in which the queue depth may be set to the current number of outstanding large read request factored by the desired large request bypass percentage (e.g., 50%), which may also be referred to herein as a desired fraction or portion of the total available saturation throughput. For example, if there were 500 large requests in flight, and the desired fraction or portion of the total available saturation throughput is set to 50%, then the queue depth for the large request queue is set to 250.

As described further below with reference to FIG. 11, the use of this separate large request queue onto which only large reads are queued for EC lookup may be used to implement a large read special bypass. Such a large read special bypass is motivated by the observation that the EC is not efficient for large reads. So, large reads gain by “giving up” use of the EC.

At decision block 1010, the current measure of saturation throughput is compared to a desired fraction or portion of the total available saturation throughput (e.g., saturation throughput (e.g., OPS) threshold 727) to determine whether and how a depth of the large request queue is to be manipulated. As noted herein, there are various measures of saturation throughput. In one example, the average throughput of all reads (EC lookups) performed within a given monitoring interval performed by a saturation monitor (e.g., saturation monitor 445) may represent the current measure of saturation throughput. The saturation throughput threshold is generally within the sweet spot or knee region (e.g., one of knee regions 715, 725, or 735, respectively) of the current read performance curve (e.g., one of curves 710, 720, or 730) observed for the EC backing storage device based on monitoring of the EC backing storage device. When the current measure of saturation throughput is above the portion of the saturation throughput threshold to which large reads are to be limited, processing continues with block 1020. When the current measure of saturation throughput is below the desired portion of the saturation throughput threshold to which large reads are to be limited, processing branches to block 1030. Otherwise, when the current measure of saturation throughput is equal to the desired portion of the saturation throughput threshold to which large reads are to be limited, no tuning is needed and processing is complete.

At block 1020, the depth of the large request queue is decreased. For example, the current depth of the large request queue may be reduced by one or more entries. In one embodiment, each entry of the large request queue may correspond to one 4KiB data block of a large read request (e.g., read request 410). Similar to that described above with reference to FIG. 9, the decrease may be in proportion to the difference between the current measure of saturation throughput and the desired fraction or portion of the total available saturation throughput allocated to large reads.

At block 1030, the depth of the large request queue is increased. For example, the current depth of the large request queue may be expanded by one or more entries. Similar to that described above with reference to FIG. 9, the decrease may be in proportion to the difference between the current measure of saturation throughput and the desired fraction or portion of the total available saturation throughput allocated to large reads.

While in the context of the present example, a depth of a large request queue maintained by the file system on which in-flight large read requests are queued pending performance of respective EC lookups is described as being increased or decreased based on a measure of saturation throughput, it is to be appreciated in other examples, other performance measures or metrics associated with the EC backing storage may be used individually or in various combinations. For example, in one embodiment, a current saturation OPS metric (e.g., percentage) may be used manipulate the large read queue depth. For example, when a current saturation OPS metric, such as one of those discussed above with reference to FIG. 6, is above a threshold, the large read queue depth may be decreased and when the current saturation OPS metric is below the threshold, the large read queue depth may be increased. As above, the rest of the OPS available may be used for small reads.

### Example Read Request Processing

FIG. 11 is a flow diagram illustrating operations for performing read processing by an EC queue depth controller (e.g., queue depth controller 435) in accordance with an embodiment of the present disclosure. As above, the processing described with reference to FIG. 11 may be performed by a queue depth controller (e.g., queue depth controller 435) implemented by a file system (e.g., file system layer 111) of a virtual storage system (e.g., one of virtual storage systems 110a-n or virtual storage system 210), for example, within a file system EC interface (e.g., file system EC interface 430). In the context of the present example, large reads are put through two filters (e.g., one relating to throughput utilization and another relating to saturation latency) and small reads are put through a single filter (e.g., relating to saturation latency). As noted above, the general idea in various examples is to preclude large reads from utilizing all available throughput of a backing storage device (e.g., ephemeral storage device 450) of an EC (e.g., EC 256 or 456). Therefore, embodiments described herein, reserve at least some portion of the available throughput of the EC backing storage device for use by small reads and additionally seek to increase the chances of large reads bypassing the EC.

At block 1010, a read request (e.g., read request 410) is received for example, by a file system EC interface (e.g., file system EC interface 430).

At decision block 1120, it is determined whether the read request is a large read. In one embodiment, a large read is a read request relating to retrieval of an amount of data meeting or exceeding a predefined or configurable large read threshold. If the read request is less than the predefined or configurable large threshold, the read is considered a small read and processing branches to decision block 1160; otherwise, the read request is considered a large read and processing continues with decision block 1130. In one embodiment, the predefined or configurable large read threshold is between 16 KiB and 64 KiB (inclusive) or four or sixteen 4 KiB data blocks (inclusive), respectively, depending on various factors (e.g., compression). In one example, the predetermined or configurable large read threshold is 32 KiB or 8 4 KiB data blocks.

At decision block 1130, a determination is made regarding whether a remaining queue depth of (or remaining space within) a large request queue (e.g., large request queue 436) is sufficient to accommodate the size of the large read (in blocks). That is, whether the large read will fit within the large request queue. If so, processing continues with decision block 1160; otherwise, processing branches to block 1180.

At decision block 1160, a determination is made regarding whether a remaining queue depth of (or remaining space within) a general request queue (e.g., general request queue 437) is sufficient to accommodate the size of the read (which may be a small read or a large read) in blocks. That is, whether the read will fit within the general request queue. If so, processing continues with block 1170; otherwise, processing branches to block 1180.

At block 1170, the read is queued on the general queue for subsequent performance of EC lookup.

At block 1180, the read bypasses the EC lookup and instead is served via a RAID subsystem (e.g., RAID subsystem 455) of the virtual storage system.

While in the context of the flow diagrams of FIGS. 6 and 8-11, a number of enumerated blocks are included, it is to be understood that examples may include additional blocks before, after, and/or in between the enumerated blocks. Similarly, in some examples, one or more of the enumerated blocks may be omitted and/or performed in a different order.

### ALTERNATIVE EMBODIMENTS

### Alternative #1: Static Saturation Latency and IOPS Based on Storage Device Specifications

According to the specifications (e.g., provided by the storage devices manufacturer or by the cloud provider) for the storge device that is used as the EC backing storage device, the storage device is qualified (or guaranteed) to provide a specific number of operations per second, or specific maximum throughput. For example, a storage device may be rated for a maximum 500,000 IOPS and 2 GB/s for reads, and a maximum of 1 GB/s for writes. In this example, the saturation OPS may be statically set to match the specified OPS provided by the device's manufacturer (or cloud provider). One potential limitation of this approach, however, is that the quoted OPS are generally determined using single synthetic, workloads which may not accurately reflect the mixed workload of operations present in External Cache systems. Another issue is that, at the quoted OPS level the latency can vary significantly due to the shared nature of physical devices in cloud environments. That is, in a cloud environment, a physical storage device is not exclusive to one single storage system and shares physical and logical connections with other systems on the same physical host.

### Alternative #2: Fixed Latency Threshold

In this example, a fixed single latency threshold may be used and, once the sampled latency exceeds the threshold, the read is bypassed. While simple and potentially effective, this approach may underutilize the EC backing storage device when writes are present and the read latency is temporarily increased, leading to too much IO being bypassed.

### Alternative #3: Precise, Complex Calculations of “Ideal” Latency vs. Throughput Point

A method can be used to calculate the latency vs. throughput threshold for the EC backing storage device, based on obtaining many samples and computing rates of change in the samples, and rate of change (second derivatives) of the rates of change of latency vs. throughput. These calculations may yield a latency/throughput point that is “ideal” for the storage device at issue; however, the drawback to such an approach is that it requires multiple measurements to be taken and stored before yielding a result, thus the results lag the sampled workload. As such, the proposed approach described herein in which the sampled latency difference relies only on the current sample and one previous sample has advantages in terms of minimizing memory requirements, less calculation complexity, and less time elapsed between sample acquisition and adjustment to the queue depth.

### Alternative #4: Do Not Use Special Large-Read Bypass Mechanism

In this example, the large request queue (e.g., large request queue 436) may be excluded and the proposed approach may rely on a single, depth of the general queue (e.g., general request queue 437) and allow large reads to consume more slots in the queue depth. In workloads with some number of sequential reads, these large sequential reads consume most of the queue depth and may starve smaller reads. Special care may be needed in this approach to ensure that if something needs to be bypassed, large reads can be more efficiently handled by the RAID back-end than small reads.

### ALTERNATIVE USAGE SCENARIOS

### Alternative Use Case #1: Asymmetric Network Connections

The various techniques described herein may alternatively be used in a scenario in which two network connections are available (e.g., two internet service providers). One of the connections (connection A) may be preferred due to lower cost or higher capacity, whereas the other connection (connection B) is equally capable but has less desirable cost or speed characteristics. In this context, the monitoring described herein may be used to monitor connection A's latency and throughput, and through the provided mechanisms, determine a queue depth that maximizes use of connection A, sending excess traffic through connection B.

### Alternative Use Case #2: Network Protocol Selection

The various techniques described herein may alternatively be used in a scenario in which point-to-point transmission of data can be achieved with two different protocols. User Datagram Protocol (UDP), which is connection-less and state-less, is well-suited for small data packets. Transmission Control Protocol (TCP), which is connection-based, is well suited for larger data transmissions, but has increased overhead that make it less performant for small transmissions.

In this context, the monitoring described herein may be used to send all data through UDP, small and large transmissions, and measure the response time (where the average latency includes retry due to packet losses). The traffic can be increased and monitored until the UDP transmissions become saturated (i.e., maximize the amount of data that is sent without losses, while minimizing the extra latency that is incurred by losses). Once the saturation point is reached, packets may then be sent with the more expensive TCP protocol. For example, the separate “large request” queue depth can be used to pro-actively make large transfers go directly through TCP, because the large transfer size can better amortize the cost of setting up a reliable connection, eliminating the inherently higher risk of packet loss that comes from larger transfers.

### Example Computer System

Embodiments of the present disclosure include various steps, which have been described above. The steps may be performed by hardware components or may be embodied in machine-executable instructions, which may be used to cause one or more processing resources (e.g., one or more general-purpose or special-purpose processors) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a non-transitory machine-readable storage medium embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or standard computer hardware to execute the code contained therein. An apparatus for practicing various embodiments of the present disclosure may involve one or more computers (e.g., physical and/or virtual servers) (or one or more processors within a single computer) and storage systems containing or having network access to computer program(s) coded in accordance with various methods described herein, and the method steps associated with embodiments of the present disclosure may be accomplished by modules, routines, subroutines, or subparts of a computer program product.

FIG. 12 is a block diagram that illustrates a computer system 1200 in which or with which an embodiment of the present disclosure may be implemented. Computer system 1200 may be representative of all or a portion of the computing resources of a physical host (e.g., host 200) on which a virtual storage system (e.g., one of virtual storage systems 110a-n or virtual storage system 210) of a distributed storage system is deployed. Notably, components of computer system 1200 described herein are meant only to exemplify various possibilities. In no way should example computer system 1200 limit the scope of the present disclosure. In the context of the present example, computer system 1200 includes a bus 1202 or other communication mechanism for communicating information, and one or more processing resources (e.g., hardware processor(s) 1204) coupled with bus 1202 for processing information. Hardware processor(s) 1204 may be, for example, one or more general purpose microprocessors.

Computer system 1200 also includes a main memory 1206, such as a random access memory (RAM) or other dynamic storage device, coupled to bus 1202 for storing information and instructions to be executed by processor 1204. Main memory 1206 also may be used for storing temporary variables or other intermediate information during execution of instructions to be executed by processor(s) 1204. Such instructions, when stored in non-transitory storage media accessible to processor(s) 1204, render computer system 1200 into a special-purpose machine that is customized to perform the operations specified in the instructions.

Computer system 1200 further includes a read only memory (ROM) 1208 or other static storage device coupled to bus 1202 for storing static information and instructions for processor(s) 1204. A storage device 1210, e.g., a magnetic disk, optical disk or flash disk (made of flash memory chips), is provided and coupled to bus 1202 for storing information and instructions.

Computer system 1200 may be coupled via bus 1202 to a display 1212, e.g., a cathode ray tube (CRT), Liquid Crystal Display (LCD), Organic Light-Emitting Diode Display (OLED), Digital Light Processing Display (DLP) or the like, for displaying information to a computer user. An input device 1214, including alphanumeric and other keys, is coupled to bus 1202 for communicating information and command selections to processor(s) 1204. Another type of user input device is cursor control 1216, such as a mouse, a trackball, a trackpad, or cursor direction keys for communicating direction information and command selections to processor(s) 1204 and for controlling cursor movement on display 1212. This input device typically has two degrees of freedom in two axes, a first axis (e.g., x) and a second axis (e.g., y), that allows the device to specify positions in a plane.

Removable storage media 1240 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computer system 1200 may implement the techniques described herein using customized hard-wired logic, one or more ASICs or FPGAs, firmware or program logic which in combination with the computer system causes or programs computer system 1200 to be a special-purpose machine. According to one embodiment, the techniques herein are performed by computer system 1200 in response to processor(s) 1204 executing one or more sequences of one or more instructions contained in main memory 1206. Such instructions may be read into main memory 1206 from another storage medium, such as storage device 1210. Execution of the sequences of instructions contained in main memory 1206 causes processor(s) 1204 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 1210. Volatile media includes dynamic memory, such as main memory 1206. Common forms of storage media include, for example, a flexible disk, a hard disk, a solid state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1202. Transmission media can also take the form of acoustic or light waves, such as those generated during radio-wave and infra-red data communications.

Various forms of media may be involved in carrying one or more sequences of one or more instructions to processor(s) 1204 for execution. For example, the instructions may initially be carried on a magnetic disk or solid state drive of a remote computer. The remote computer can load the instructions into its dynamic memory and send the instructions over a telephone line using a modem. A modem local to computer system 1200 can receive the data on the telephone line and use an infra-red transmitter to convert the data to an infra-red signal. An infra-red detector can receive the data carried in the infra-red signal and appropriate circuitry can place the data on bus 1202. Bus 1202 carries the data to main memory 1206, from which processor(s) 1204 retrieve and execute the instructions. The instructions received by main memory 1206 may optionally be stored on storage device 1210 either before or after execution by processor(s) 1204.

Computer system 1200 also includes a communication interface 1218 coupled to bus 1202. Communication interface 1218 provides a two-way data communication coupling to a network link 1220 that is connected to a local network 1222. For example, communication interface 1218 may be an integrated services digital network (ISDN) card, cable modem, satellite modem, or a modem to provide a data communication connection to a corresponding type of telephone line. As another example, communication interface 1218 may be a local area network (LAN) card to provide a data communication connection to a compatible LAN. Wireless links may also be implemented. In any such implementation, communication interface 1218 sends and receives electrical, electromagnetic or optical signals that carry digital data streams representing various types of information.

Network link 1220 typically provides data communication through one or more networks to other data devices. For example, network link 1220 may provide a connection through local network 1222 to a host computer 1224 or to data equipment operated by an Internet Service Provider (ISP) 1226. ISP 1226 in turn provides data communication services through the worldwide packet data communication network now commonly referred to as the “Internet” 1228. Local network 1222 and Internet 1228 both use electrical, electromagnetic or optical signals that carry digital data streams. The signals through the various networks and the signals on network link 1220 and through communication interface 1218, which carry the digital data to and from computer system 1200, are example forms of transmission media.

Computer system 1200 can send messages and receive data, including program code, through the network(s), network link 1220 and communication interface 1218. In the Internet example, a server 1230 might transmit a requested code for an application program through Internet 1228, ISP 1226, local network 1222 and communication interface 1218. The received code may be executed by processor(s) 1204 as it is received, or stored in storage device 1210, or other non-volatile storage for later execution.

All examples and illustrative references are non-limiting and should not be used to limit the applicability of the proposed approach to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
sampling, by a virtual storage system, a measure of saturation throughput and a measure of saturation latency of an external cache (EC) of the virtual storage system;
receiving, by the virtual storage system, a read request to retrieve an amount of data greater than or equal to a large read threshold; and
based at least in part on the measure of saturation throughput and the measure of saturation latency, selectively (i) performing, by the virtual storage system, a lookup into the EC to service the read request or (ii) bypassing, by the virtual storage system, the lookup into the EC by directing the read request to a persistent storage subsystem of the virtual storage system to service the read request.

2. The method of claim 1, wherein an available throughput of the backing storage device is controlled by a hyperscaler, and wherein the method further comprises reserving, by the virtual storage system, some portion of the available throughput for use by small read requests, relating to retrieval of respective amounts of data less than the predetermined or configurable large read threshold, by limiting utilization of the available throughput by large read requests, relating to retrieval of respective amounts of data greater than or equal to the predetermined or configurable large read threshold, to a portion of the available throughput.

3. The method of claim 2, wherein the method further comprises:
based on the monitoring, determining, by the virtual storage system, a current read performance profile of the backing storage device;
based on the current read performance profile, determining, by the virtual storage system, a saturation point of the backing storage device; and
based on the measure of saturation, driving, by the virtual storage system, utilization of the backing storage toward the saturation point.

4. The method of claim 3, wherein said driving, by the virtual storage system, utilization of the backing storage toward the saturation point comprises updating a depth of a general EC lookup request queue maintained by the virtual storage system onto which all in-flight read requests, regardless of size, for which respective lookups into the EC are to be performed are placed.

5. The method of claim 4, wherein said limiting utilization of the available throughput by large read requests comprises maintaining, by the virtual storage system, a large EC lookup request queue on which those of the large read requests for which respective lookups into the EC are to be performed are placed.

6. The method of claim 5, further comprising based on the measure of saturation throughput, updating, by the virtual storage system, a depth of the large EC lookup request queue.

7. The method of claim 6, wherein said performing, by the virtual storage system, a lookup into the EC to service the read request includes, based on both (i) the large EC lookup request queue being able to accommodate the read request and (ii) the general EC lookup request queue being able to accommodate the read request, adding, by the virtual storage system, the read request to the general EC lookup request queue.

8. A non-transitory machine readable medium storing instructions, which when executed by one or more processing resources of a storage system, cause the storage system to:
monitor a measure of saturation throughput and a measure of saturation latency of an external cache (EC) of the storage system;
receive a read request to retrieve an amount of data greater than or equal to a large read threshold; and
based at least in part on the measure of saturation throughput and the measure of saturation latency, selectively (i) perform a lookup into the EC to service the read request or (ii) bypass the lookup into the EC by directing the read request to a redundant array of independent disks (RAID) subsystem of the virtual storage system to service the read request.

9. The non-transitory machine readable medium of claim 8, wherein an available throughput of the EC is controlled by a hyperscaler, and wherein the instructions further cause the storage system to reserve some portion of the available throughput for use by small read requests, relating to retrieval of respective amounts of data less than the large read threshold, by limiting utilization of the available throughput by large read requests, relating to retrieval of respective amounts of data greater than or equal to the large read threshold, to a portion of the available throughput.

10. The non-transitory machine readable medium of claim 9, wherein the instructions further cause the storage system to:
based on monitoring the measure of saturation throughput and the measure of saturation latency, determine a current read performance profile of the EC;
based on the current read performance profile, determine a saturation point of the EC; and
based on the measure of saturation, drive utilization of the EC toward the saturation point by throttling concurrent reads to the EC.

11. The non-transitory machine readable medium of claim 10, wherein driving the utilization of the EC toward the saturation point comprises updating a depth of a general EC lookup request queue maintained by the storage system onto which all in-flight read requests, regardless of size, for which respective lookups into the EC are to be performed are placed.

12. The non-transitory machine readable medium of claim 11, wherein limiting utilization of the available throughput by large read requests comprises maintaining a large EC lookup request queue on which those of the large read requests for which respective lookups into the EC are to be performed are placed.

13. The non-transitory machine readable medium of claim 12, wherein the instructions further cause the storage system to, based on the measure of saturation throughput, update a depth of the large EC lookup request queue.

14. The non-transitory machine readable medium of claim 13, wherein performing the lookup into the EC to service the read request includes, based on both (i) the large EC lookup request queue being able to accommodate the read request and (ii) the general EC lookup request queue being able to accommodate the read request, adding the read request to the general EC lookup request queue.

15. The non-transitory machine readable medium of claim 9, wherein the measure of saturation throughput comprises an average number of operations per second associated with performing lookups into the EC during a predefined or configurable monitoring interval, and wherein the measure of saturation latency comprises an average latency associated with performing the lookups into the EC during the predefined or configurable monitoring interval.

16. The non-transitory machine readable medium of claim 9, wherein the storage system comprises a virtual storage system and wherein a backing storage device for the EC comprises a nonvolatile memory express (NVMe) solid-state disk (SSD) associated with a host on which the virtual storage system is operating and wherein the instructions further cause the storage system to determine, based on the monitoring of the measure of saturation throughput and the measure of saturation latency, a plurality of points on a current read performance profile for the NVMe SSD.

17. The non-transitory machine readable medium of claim 15, wherein the instructions further cause the storage system to shorten or lengthen the predefined or configurable monitoring interval based on a proximity of a first point on the current read performance profile represented by the measure of saturation throughput and the measure of saturation latency to a second point on the current read performance profile corresponding to a predetermined or configurable saturation throughput threshold and a predetermined or configurable saturation latency threshold.

18. A virtual storage system comprising:
one or more processing resources; and
instructions that when executed by the one or more processing resources cause the virtual storage system to:
receive a read request to retrieve an amount of data greater than or equal to a predetermined or configurable large read threshold; and
based at least in part on a measure of saturation throughput and a measure of saturation latency of an external cache (EC) of the virtual storage system, selectively (i) perform a lookup into the EC to service the read request or (ii) bypass the lookup into the EC by directing the read request to a redundant array of independent disks (RAID) subsystem of the virtual storage system to service the read request.

19. The virtual storage system of claim 18, wherein an available throughput of the backing storage device is controlled by a hyperscaler, and wherein the instructions further cause the virtual storage system to reserve some portion of the available throughput for use by small read requests, relating to retrieval of respective amounts of data less than the predetermined or configurable large read threshold, by limiting utilization of the available throughput by large read requests, relating to retrieval of respective amounts of data greater than or equal to the predetermined or configurable large read threshold, to a portion of the available throughput.

20. The virtual storage system of claim 19, wherein the instructions further cause the virtual storage system to:
monitor the measure of saturation throughput and the measure of saturation latency of the EC;
based on monitoring of the measure of saturation throughput and the measure of saturation latency of the EC, determine a current read performance profile of the backing storage device;
based on the current read performance profile, determine a saturation point of the backing storage device; and
based on the measure of saturation, drive utilization of the backing storage toward the saturation point.

21. The virtual storage system of claim 20, wherein driving the utilization of the backing storage toward the saturation point comprises updating a depth of a general EC lookup request queue maintained by the virtual storage system onto which all in-flight read requests, regardless of size, for which respective lookups into the EC are to be performed are placed.

22. The virtual storage system of claim 21, wherein limiting utilization of the available throughput by large read requests comprises maintaining a large EC lookup request queue on which those of the large read requests for which respective lookups into the EC are to be performed are placed.

23. The virtual storage system of claim 22, wherein the instructions further cause the virtual storage system to, based on the measure of saturation throughput, update a depth of the large EC lookup request queue.

24. The virtual storage system of claim 23, wherein performing the lookup into the EC to service the read request includes, based on both (i) the large EC lookup request queue being able to accommodate the read request and (ii) the general EC lookup request queue being able to accommodate the read request, adding the read request to the general EC lookup request queue.
